(19) United States
(12) Patent Application Publication
(10) Pub. No.: US 2006/0237301 A1
(43) Pub. Date: Oct. 26, 2006

(54) Apparatus for producing nanocarbon, method for producing nanocarbon and method for collecting nanocarbon

(76) Inventors: Takeshi Azami, Tokyo (JP); Daisuke Kasuya, Tokyo (JP); Tsutomu Yoshitake, Tokyo (JP); Yoshimi Kubo, Tokyo (JP); Sumio Iijima, Tokyo (JP); Masako Yudasaka, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/566,579

(22) PCT Filed: Aug. 5, 2004
(86) PCT No.: PCT/JP04/11262

§ 371 Date: Jan. 31, 2006

(30) Foreign Application Priority Data
Aug. 8, 2003 (JP) 2003-289863

(51) Int. Cl. D01F 9/12; B01J 19/08; C01B 31/00

(52) U.S. Cl. 204/157.47; 423/447.1; 977/844; 422/186

(57) ABSTRACT

In a nanocarbon manufacturing apparatus (183), a spray (181) is provided at a side face of a nanocarbon recovery chamber (119), and a mist (195) is sprayed on the entire nanocarbon recovery chamber (119) from the spray (181).

### TECHNICAL FIELD

The present invention relates to a nanocarbon manufacturing apparatus, and methods of manufacturing and recovering a nanocarbon.

### BACKGROUND ART

In recent years, technological applications of nanocarbon have been actively under review. Nanocarbon means carbon material having a nanoscale microstructure which is typified by a carbon nanotube, a carbon nanohorn, or the like. Among these, carbon nanohorn has a tube-shaped structure in which one edge of a carbon nanotube that a graphite sheet is made round cylindrically has a conical shape, and is expected to be applied to various technical fields from the unique characteristic thereof. Usually, carbon nanohorns form a carbon nanohorn assembly so as to gather in a form in which the conical portions are projected like a horn at the surface centering around the tube by van der Waals force acting between conical portions.

It has been reported that a carbon nanohorn assembly is manufactured by a laser vaporization method in which a laser beam is irradiated onto carbon material (hereinafter, referred to as a graphite target appropriately) which is a raw material, in the inert gas atmosphere (Patent Document 1). In accordance with this method, the sooty material obtained by laser vaporization should be recovered by using a method of appropriately depositing sooty material on a substrate, or the like.
[Patent Document 1] Japanese Laid-open patent publication No. 2001-64004

### DISCLOSURE OF THE INVENTION

However, as the result of the study of this method by the inventors, it has become apparent that it is difficult to recover generated sooty material. In particular, carbon nanohorn assemblies easily drift on the air because of the low density, and float in a chamber, and it has been difficult for the carbon nanohorn assemblies to be deposited on the bottom of the chamber.

The present invention has been achieved in consideration of the above-described circumstances, and an object of the present invention is to provide a technology of efficiently recovering nanocarbon.

According to the present invention, there is provided a nanocarbon manufacturing apparatus including a generation chamber which generates nanocarbon, and a recovery chamber which recovers generated nanocarbon, wherein a moistening unit which moistens generated nanocarbon is provided in the generation chamber or the recovery chamber.

According to the manufacturing apparatus of the present invention, because the moistening unit is provided in the generation chamber or the recovery chamber, nanocarbon generated in the generation chamber may be certainly moistened. Therefore, the nanocarbon is restrained from floating in the recovery chamber, and may be deposited on the bottom. Therefore, the deposited nanocarbon may be certainly recovered.

In the present invention, in the generation chamber, nanocarbon is generated by a method such as, for example, a laser ablation method, an arc discharge method, a CVD method, or the like.

According to the present invention, there is provided a nanocarbon manufacturing apparatus including a light source which irradiates light onto a surface of a graphite target, a recovery unit which recovers nanocarbon generated in irradiation of the light, and a moistening unit which moistens the nanocarbon.

According to the nanocarbon manufacturing apparatus according to the present invention, because the moistening unit which moistens nanocarbon is provided, generated nanocarbon are moistened, and may be precipitated. Therefore, the nanocarbon may be restrained from floating, and may be efficiently recovered.

In the nanocarbon manufacturing apparatus of the present invention, the moistening unit may be a spray unit. In accordance with this way, generated nanocarbon may be certainly moistened by mist. Therefore, the nanocarbon may be more easily recovered. In the present invention, the spray unit may be, for example, an ethanol atomization device.

In the nanocarbon manufacturing apparatus of the present invention, the recovery unit has a recovery chamber, and a recovery pipe which guides the nanocarbon into the recovery chamber, and the moistening unit may moisten the nanocarbon in the recovery chamber. In accordance with this way, generated nanocarbon may be efficiently guided into the recovery chamber. Further, the nanocarbon recovered in the recovery chamber may be certainly moistened. Therefore, the nanocarbon may be deposited in the recovery chamber, and may be certainly recovered.

In the nanocarbon manufacturing apparatus of the present invention, the bottom face of the recovery chamber may be inclined against a face on which the apparatus is installed. In accordance with this way, moistened nanocarbon may be more easily recovered. Further, the recovery chamber may be structured so as to be attachable and detachable. In accordance therewith Because the recovery chamber may be detached in this may, the nanocarbon may be easily recovered.

In the nanocarbon manufacturing apparatus of the present invention, the generation chamber in which the graphite target is installed is provided, and the moistening unit may moisten the nanocarbon in the generation chamber. In accordance with this way, the generated nanocarbon may be certainly moistened. Therefore, the nanocarbon is restrained from floating in the generation chamber, and may be easily recovered. Further, because the nanocarbon does not float in the generation chamber, the blurring of the power density of a light irradiated onto the graphite target may be suppressed. Therefore, nanocarbon having a desired property may be stably manufactured.

In the manufacturing apparatus of the present invention, a recovery equipment into which generated nanocarbon is recovered may be provided at the bottom of the generation chamber. When this is done, the nanocarbon moistened in the generation chamber may be deposited in the recovery equipment. Therefore, the nanocarbon may be efficiently recovered. The recovery equipment may have a moistening unit.

According to the present invention, there is provided a nanocarbon manufacturing apparatus including a generation chamber which generates nanocarbon, and a recovery chamber which recovers generated nanocarbon, wherein a moistening unit which moistens generated nanocarbon is provided in the generation chamber or the recovery chamber.

According to the present invention, there is provided a method of manufacturing nanocarbon including a step of irradiating light onto a surface of a graphite target, and a step of moistening nanocarbon generated at the step of irradiating light.

According to the manufacturing method according to the present invention, because the step of moistening generated nanocarbon is included, nanocarbon may be restrained from floating. Therefore, the nanocarbon may be efficiently recovered. Further, the nanocarbon may be certainly recovered.

In the method of manufacturing nanocarbon of the present invention, the step of moistening nanocarbon may include a step of spraying liquid on the nanocarbon. In accordance with this way, the nanocarbon may be certainly moistened. Therefore, the nanocarbon may be more certainly recovered.

In the method of manufacturing nanocarbon of the present invention, the step of moistening nanocarbon may include a step of spraying an organic solvent on the nanocarbon. Because the surface of the nanocarbon is hydrophobic, the nanocarbon may be more certainly moistened by spraying an organic solvent.

In the method of manufacturing nanocarbon of the present invention, the step of moistening nanocarbon may spray alcohol or an aqueous solution thereof on the nanocarbon. Because alcohol is excellent in volatile, due to alcohol or an aqueous solution thereof being sprayed, it is easy to remove a spray liquid from recovered nanocarbon. In the manufacturing method of the present invention, for example, ethanol, methanol, isopropyl alcohol, or an aqueous solution thereof may be sprayed.

According to the present invention, there is provided a method of recovering nanocarbon including, after nanocarbon is generated, moistening and recovering the nanocarbon. According to the recovery method relating to the present invention, because generated nanocarbon is moistened, the nanocarbon may be restrained from floating, and the nanocarbon may be easily recovered.

As described above, according to the present invention, nanocarbon may be efficiently recovered.

### BRIEF DESCRIPTION OF THE DRAWINGS

The objects described above, and the other objects, features, and advantages will become further apparent from the preferred embodiments which will be described below, and the accompanying following drawings.

FIG. 1 is a diagram showing a structure of a carbon nanohorn manufacturing apparatus according to an embodiment.

FIG. 2 is a cross-sectional view in a direction of A-A′ of the nanocarbon manufacturing apparatus of FIG. 1.

FIG. 3 is a diagram showing a structure of a carbon nanohorn manufacturing apparatus according to an embodiment.

FIG. 4 is a cross-sectional view in a direction of B-B′ of the nanocarbon manufacturing apparatus of FIG. 3.

FIG. 5 is a diagram showing a structure of a nozzle of a sprayer of FIG. 4.

FIG. 6 is a diagram showing a structure of a carbon nanohorn manufacturing apparatus according to an embodiment.

FIG. 7 is a diagram showing a structure of a carbon nanohorn manufacturing apparatus according to an embodiment.

FIG. 8 is a diagram showing a structure of a carbon nanohorn manufacturing apparatus according to an embodiment.

FIG. 9 is a diagram showing a structure of a carbon nanohorn manufacturing apparatus according to an embodiment.

### BEST MODE FOR CARRYING OUT THE INVENTION

Hereinafter, cases in which carbon nanohorn assemblies are manufactured by a laser ablation method, and are recovered will be described as examples. Note that, in all the drawings, common components are denoted by the same reference numerals, and description thereof will not be appropriately shown.

### First Embodiment

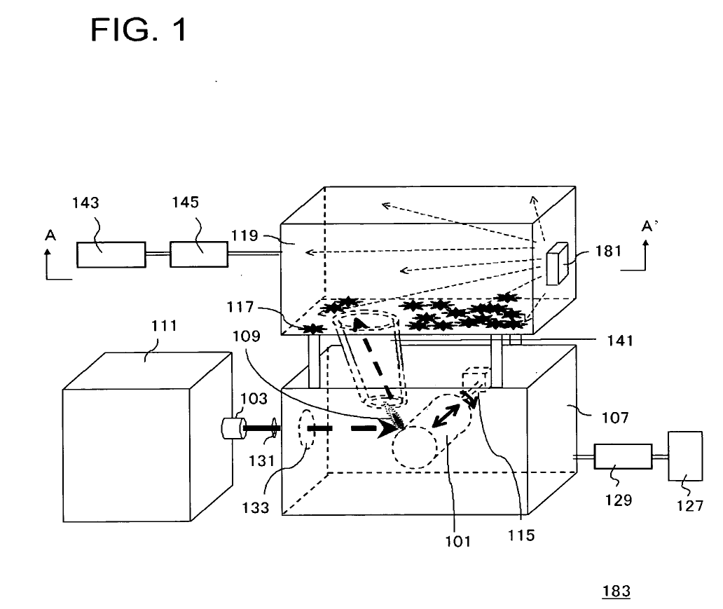

In the present embodiment, a chamber for recovering nanocarbon is provided in a nanocarbon manufacturing apparatus, and a spray device for moistening nanocarbon is provided at the chamber for recovering. FIG. 1 is a diagram showing a structure of a nanocarbon manufacturing apparatus 183 of the present embodiment. Note that, in this specification, FIG. 1 and the other drawings used for describing a manufacturing apparatus are schematic diagrams, and the sizes of respective constructional members do not necessarily correspond to actual dimensional ratio.

The nanocarbon manufacturing apparatus 183 of FIG. 1 has a manufacturing chamber 107, a nanocarbon recovery chamber 119, a carrier pipe 141, a laser light source 111, a ZnSe plano-convex lens 131, a ZnSe window 133, a rotation device 115, and a sprayer 181. Moreover, the nanocarbon manufacturing apparatus 183 has an inert gas feeding unit 127, a flow meter 129, a vacuum pump 143, and a pressure gage 145.

A laser beam 103 emitted from the laser light source 111 is condensed at the ZnSe plano-convex lens 131, and is irradiated onto a graphite rod 101 in the manufacturing chamber 107 via the ZnSe window 133. The graphite rod 101 is used as a solid-state carbon simple substance which will be a target of irradiation of the laser beam 103.

The laser beam 103 is irradiated onto the graphite rod 101 so as to have a constant illuminating angle. Due to the graphite rod 101 being rotated at a predetermined speed with respect to the central axis thereof while maintaining the illuminating angle of the laser beam 103 to be constant, the laser beam 103 can be continuously irradiated at a constant power density in the circumferential direction of the side face of the graphite rod 101. Further, due to the graphite rod 101 being slid in the length direction, the laser beam 103 can be continuously irradiated at a constant power density in the length direction of the graphite rod 101.

The rotation device 115 holds the graphite rod 101, and rotates the graphite rod 101 around the central axis. The graphite rod 101 can be rotated around the central axis by being fixed to the rotation device 115. Further, the graphite rod 101 may be structured so as to be able to move the position in a direction along the central axis.

The manufacturing chamber 107 and the nanocarbon recovery chamber 119 are connected through the carrier pipe 141. The laser beam 103 is irradiated from the laser light source 111 onto the side face of the graphite rod 101, and in a direction of generation of a plume 109 at that time, the nanocarbon recovery chamber 119 is provided via the carrier pipe 141, and carbon nanohorn assemblies 117 which have been generated are recovered into the nanocarbon recovery chamber 119.

The sprayer 181 is provided at the nanocarbon recovery chamber 119, and is structured so as to be able to spray liquid to the inside and onto the wall surfaces of the nanocarbon recovery chamber 119. In this way, the carbon nanohorn assemblies 117 recovered in the nanocarbon recovery chamber 119 can be moistened. Therefore, the carbon nanohorn assemblies 117 recovered in the nanocarbon recovery chamber 119 can be efficiently deposited on the bottom of the nanocarbon recovery chamber 119, and can be recovered.

Here, the sprayer 181 may be an atomization device having an atomizing unit. Further, the sprayer 181 may be structured such that a spray liquid is discharged so as to be a shower from a solvent tank. Moreover, the sprayer 181 may be a spray device utilizing a structure of a sprinkler or the like. In the present embodiment, a case in which the sprayer 181 has an atomizing unit will be described hereinafter as an example.

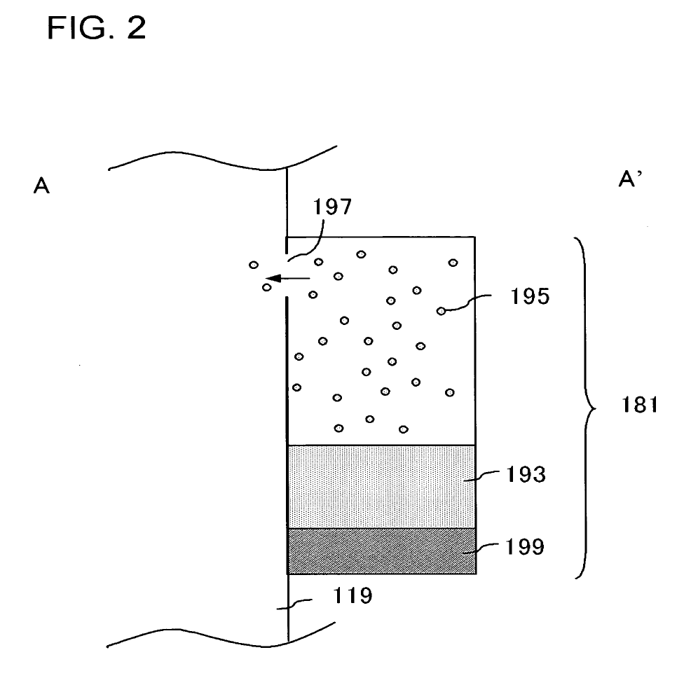

FIG. 2 is a diagram schematically showing the sprayer 181 having an atomizing unit. Note that FIG. 2 is a cross-sectional view in the A-A′ direction of FIG. 1.

The sprayer 181 of FIG. 2 has an atomizing unit 199, and a spray liquid 193 is received above the atomizing unit 199. The nanocarbon recovery chamber 119 and the sprayer 181 are coupled to one another via a through aperture 197 provided at a part of the wall surface of the nanocarbon recovery chamber 119. The spray liquid 193 is sprayed as a mist 195 from the through aperture 197 into the nanocarbon recovery chamber 119.

The atomizing unit 199 produces a high-frequency vibration such as, for example, an ultrasonic vibration. This vibration is conducted to the spray liquid 193 via the sprayer 181. The spray liquid 193 is atomized by this vibration to generate the mist 195. The mist 195 passes through the through aperture 197 to go into the nanocarbon recovery chamber 119.

As the atomizing unit 199, an ultrasonic vibration atomizing unit such as, for example, USH-400 manufactured by Akizuki Denshi Co., Ltd., C-HM-2412 marketed by TECH-JAM CO., LTD., or the like can be quoted. Such an atomizing unit can atomize the spray liquid 193 with a high response. Further, an ultrasonic vibration atomizing unit having a piezoelectric vibrator, such as an atomizing disk manufactured by FDK CORPORATION, may be used. Because such an atomizing unit is a low power consumption type, it is possible to efficiently generate the mist 195.

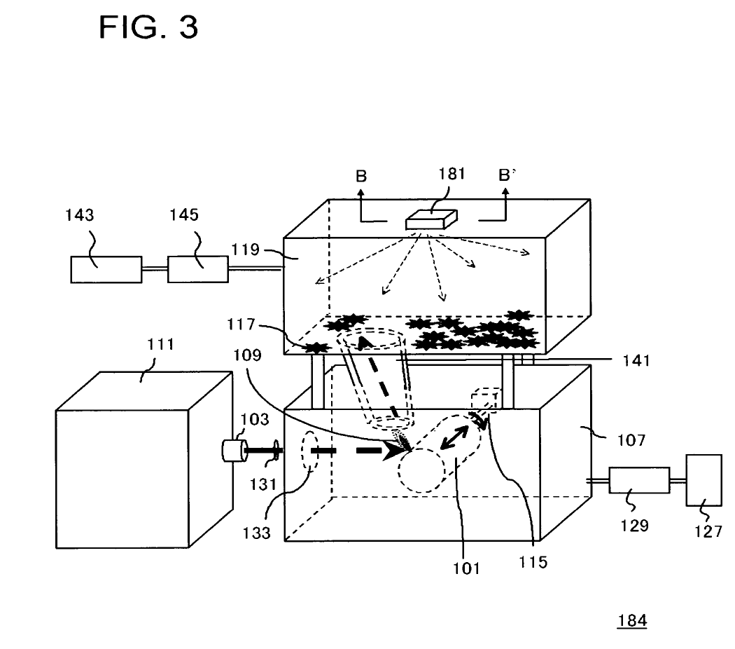

In the nanocarbon manufacturing apparatus 183, the sprayer 181 is provided at the side face of the nanocarbon recovery chamber 119. However, the sprayer 181 may be provided at the top face or the bottom face of the nanocarbon recovery chamber 119. For example, FIG. 3 is in the same way as the basic structure of the nanocarbon manufacturing apparatus 183 of FIG. 1. However, FIG. 3 is a diagram showing a nanocarbon manufacturing apparatus 184 having the sprayer 181 at the top face of the nanocarbon recovery chamber 119.

Further, a plurality of sprays 181 may be provided respectively at different faces of the nanocarbon recovery chamber 119. In this way, because the respective wall surfaces of the nanocarbon recovery chamber 119 can be more certainly moistened, the carbon nanohorn assemblies 117 can be certainly recovered.

Next, returning to FIG. 1, a method of manufacturing the carbon nanohorn assemblies 117 using the nanocarbon manufacturing apparatus 183 will be concretely described.

In the nanocarbon manufacturing apparatus 183, as the graphite rod 101, a high-purity graphite, for example, a rod-shaped sintered carbon, a compression molded carbon, or the like can be used.

Further, as the laser beam 103, for example, a high-power CO₂ gas laser can be used. Irradiation of the laser beam 103 onto the graphite rod 101 is carried out in the inert gas atmosphere including noble gases such as Ar, He, and the like, for example, in the atmosphere which is greater than or equal to 10³ Pa and less than or equal to 10⁵ Pa. Further, it is preferable to make the inert gas atmosphere after the interior of the manufacturing chamber 107 is evacuated to be, for example, less than or equal to 10⁻² Pa in advance.

Further, it is preferable to adjust the output, the spot diameter, and the illuminating angle of the laser beam 103 such that the power density of the laser beam 103 at the side face of the graphite rod 101 is made to be substantially constant, for example, greater than or equal to 5 kW/cm² and less than or equal to 25 kW/cm².

The output of the laser beam 103 is, for example, greater than or equal to 1 kW and less than or equal to 50 kW. Further, a pulse duration of the laser beam 103 is, for example, greater than or equal to 0.5 seconds, and is preferably greater than or equal to 0.75 seconds. In this way, it is possible to sufficiently acquire the accumulated energy of the laser beam 103 irradiated onto the surface of the graphite rod 101. Therefore, the carbon nanohorn assemblies 117 can be efficiently manufactured. Further, a pulse duration of the laser beam 103 is, for example, less than or equal to 1.5 seconds, and is preferably less than or equal to 1.25 seconds. According to this manner, the energy density on the surface varies due to the surface of the graphite rod 101 being heated excessively, and the yield of the nanohorn assemblies can be restrained from being reduced. It is more preferable for a pulse duration of the laser beam 103 to be greater than or equal to 0.75 seconds and less than or equal to 1 second. In accordance therewith, both of the generation rate and the yield of the carbon nanohorn assemblies 117 can be improved.

Further, a pause duration in the irradiation of the laser beam 103 may be, for example, greater than or equal to 0.1 seconds, and is preferably greater than or equal to 0.25 seconds. In accordance therewith, the surface of the graphite rod 101 can be more certainly restrained from being excessively heated.

The laser beam 103 is irradiated so as to have a constant illuminating angle. Due to the graphite rod 101 being rotated at a predetermined speed with respect to the central axis thereof while maintaining the illuminating angle of the laser beam 103 to be constant, the laser beam 103 can be continuously irradiated at a constant power density in the circumferential direction of the side face of the graphite rod 101. Further, due to the graphite rod 101 being slid in the length direction, the laser beam 103 can be continuously irradiated at a constant power density in the length direction of the graphite rod 101.

It is preferable for the illuminating angle at that time to be greater than or equal to 30° and less than or equal to 60°. Note that, in this specification, the illuminating angle means an angle formed between the perpendicular line with respect to the surface of the graphite target at a position onto which the laser beam 103 has been irradiated and the laser beam 103. When a cylindrical graphite target is used, the illuminating angle is made to be an angle formed between the line segment connecting an irradiated position and the center of the circle, and the horizontal surface in the cross-section perpendicular to the length direction of the graphite rod 101.

Due to the illuminating angle being made to be greater than or equal to 30°, reflection of the laser beam 103 to be irradiated, that is, generation of a return light can be prevented. Further, the plume 109 to be generated is prevented from hitting the ZnSe plano-concave lens 131 directly through the ZnSe window 133. Therefore, the ZnSe plano-concave lens 131 is protected, which is effective for preventing the carbon nanohorn assemblies 117 from adhering to the ZnSe window 133. Further, due to the laser beam 103 being irradiated at an angle less than or equal to 60°, generation of amorphous carbon is restrained, and the ratio of the carbon nanohorn assemblies 117 among the product, namely, the yield of the carbon nanohorn assemblies 117 can be improved. Further, it is particularly preferable for the illuminating angle to be 45°±5°. Due to the laser beam 103 being irradiated at an angle of about 45°, the ratio of the carbon nanohorn assemblies 117 among the product can be further improved.

Further, the spot diameter of the laser beam 103 onto the side face of the graphite rod 101 at the time of irradiation may be, for example, greater than or equal to 0.5 mm and less than or equal to 5 mm.

Further, it is preferable for the spot of the laser beam 103 to move at a speed greater than or equal to 0.01 mm/sec and less than or equal to 55 mm/sec (linear velocity). For example, when the laser beam 103 is irradiated onto the surface of the graphite target whose diameter is 100 mm, the graphite rod 101 whose diameter is 100 mm is rotated in the circumferential direction at a constant speed by the rotation device 115, and provided that the number of rotations is, for example, greater than or equal to 0.01 rpm and less than or equal to 10 rpm, the above-described linear velocity can be realized.

Note that there is particularly no limit to the rotation direction of the graphite rod 101. However, it is preferable for the graphite rod 101 to be rotated in a direction in which an irradiated position goes away from the laser beam 103, namely, a direction from the laser beam 103 toward the carrier pipe 141 as shown by an arrow in FIG. 1. In accordance therewith, the carbon nanohorn assemblies 117 can be more certainly recovered.

The sooty material recovered into the nanocarbon recovery chamber 119 includes the carbon nanohorn assemblies 117 mainly, and is recovered as a material, for example, in which the carbon nanohorn assemblies 117 of greater than or equal to 90 wt % thereof are included.

Note that, because the plume 109 is generated in the direction perpendicular to the tangent line to the graphite rod 101 at a position onto which the laser beam 103 has been irradiated, provided that the carrier pipe 141 is provided in this direction, carbon vapor can be efficiently guided into the nanocarbon recovery chamber 119, and the carbon nanohorn assemblies 117 can be recovered.

At the time of manufacturing the carbon nanohorn assemblies 117, the mist 195 is sprayed in advance from the sprayer 181 provided at the nanocarbon recovery chamber 119. In accordance therewith, the carbon nanohorn assemblies 117 recovered in the nanocarbon recovery chamber 119 are moistened by the sprayed liquid. Therefore, the carbon nanohorn assemblies 117 are restrained from splashing in the nanocarbon recovery chamber 119, and the carbon nanohorn assemblies 117 can be efficiently deposited on the bottom of the nanocarbon recovery chamber 119. Further, the carbon nanohorn assemblies 117 can be restrained from adhering to the wall surfaces of the nanocarbon recovery chamber 119. Therefore, the recovery rate of the carbon nanohorn assemblies 117 can be improved.

It is preferable for the mist 195 to be sprayed from the sprayer 181 so as to reach and moisten all the wall surfaces of the nanocarbon recovery chamber 119. In this way, the carbon nanohorn assemblies 117 can be more certainly precipitated on the bottom of the nanocarbon recovery chamber 119.

It is preferable for the mist 195 sprayed from the sprayer 181 to be an organic solvent which is relatively hydrophobic. Because the surfaces of the carbon nanohorn assemblies 117 are relatively hydrophobic, the carbon nanohorn assemblies 117 can be certainly moistened due to this reason. Further, it is preferable to use a volatile solvent as the mist 195. In accordance therewith, the carbon nanohorn assemblies 117 can be easily dried after recovering those.

Accordingly, for example, alcohols such as ethanol, methanol, isopropyl alcohol, or the like, aromatic hydrocarbon such as benzene, toluene, or the like, halogenated hydrocarbon, ethers, amides, or the like can be sprayed. These solvents may be sprayed separately, and may be used such that two types or more are mixed. Further, it may be made to be a mixed solvent of these solvents and water.

Spraying of liquid from the sprayer 181 may be intermittently carried out at predetermined intervals, and may be continuously carried out. The spray amount and the spray velocity of the liquid can be appropriately set in accordance with a size of the nanocarbon recovery chamber 119, or the like.

In the present embodiment, for example, in the nanocarbon manufacturing apparatus 183 of FIG. 1, at the time of carrying out the manufacture of carbon nanohorn assemblies given that the graphite rod 101 is a rod-shaped sintered carbon of Φ100 mm×250 mm, and due to a CO₂ laser being irradiated onto the side face of the graphite rod 101 under the pulse conditions that a laser is oscillated for is at a pause of 250 ms, because purified sooty material can be deposited on the bottom of the nanocarbon recovery chamber 119 by spraying ethanol from the sprayer 181, the recovery rate of purified carbon nanohorn assemblies can be improved.

### Second Embodiment

In the nanocarbon manufacturing apparatus 183 or the nanocarbon manufacturing apparatus 184 described in the first embodiment, the structure of the sprayer 181 may be made as follows. Here, the case of the nanocarbon manufacturing apparatus 184 of FIG. 3 will be described as an example.

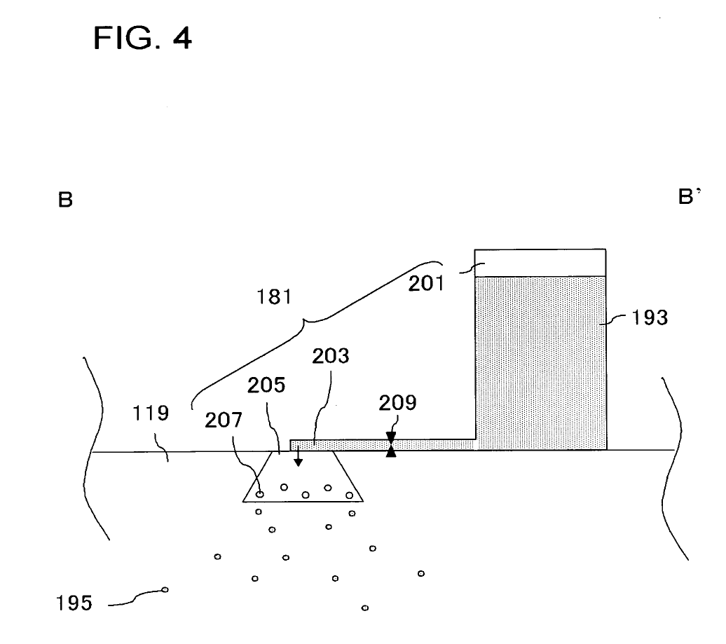

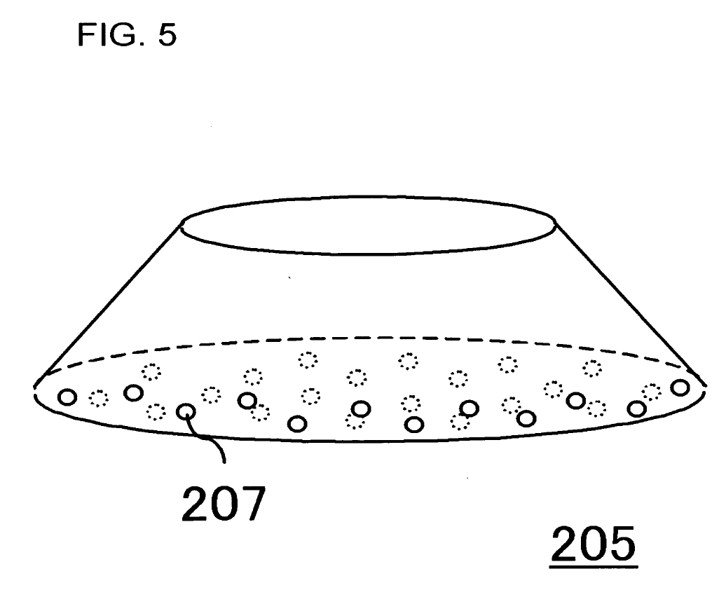

FIG. 4 is a cross-sectional view of the nanocarbon manufacturing apparatus 184 in the B-B′ direction of FIG. 3, and is a diagram for explanation of the structure of the sprayer 181. In FIG. 4, the sprayer 181 has a tank 201, a feeding pipe 203, and a nozzle 205. The spray liquid 193 is received in the tank 201. Further, the feeding pipe 203 connects the tank 201 and the nozzle 205. A valve 209 for adjusting feeding of the spray liquid 193 from the tank 201 is provided at the feeding pipe 203. The nozzle 205 is formed in a watering pot shape having many pores 207. FIG. 5 is a perspective view showing a structure of the nozzle 205.

At the time of manufacturing the carbon nanohorn assemblies 117, the valve 209 is opened, and the spray liquid 193 is sprayed into the nanocarbon recovery chamber 119 from the nozzle 205. Because the spray liquid 193 is sprayed so as to be a shower as the mist 195 through the pores 207, the entire nanocarbon recovery chamber 119 can be suitably moistened. Therefore, the carbon nanohorn assemblies 117 can be certainly precipitated and deposited on the bottom of the nanocarbon recovery chamber 119.

Note that the structure of the nozzle 205 is not limited to the aspect described above, and can be appropriately selected in accordance with a size of the nanocarbon recovery chamber 119 and a generated amount of nanocarbon. For example, a pressure type nozzle may be used. Further, feeding of the spray liquid 193 may be carried out by using a pump or the like. In accordance therewith, the spray liquid 193 can be more certainly sprayed onto the entire interior of the nanocarbon recovery chamber 119.

### Third Embodiment

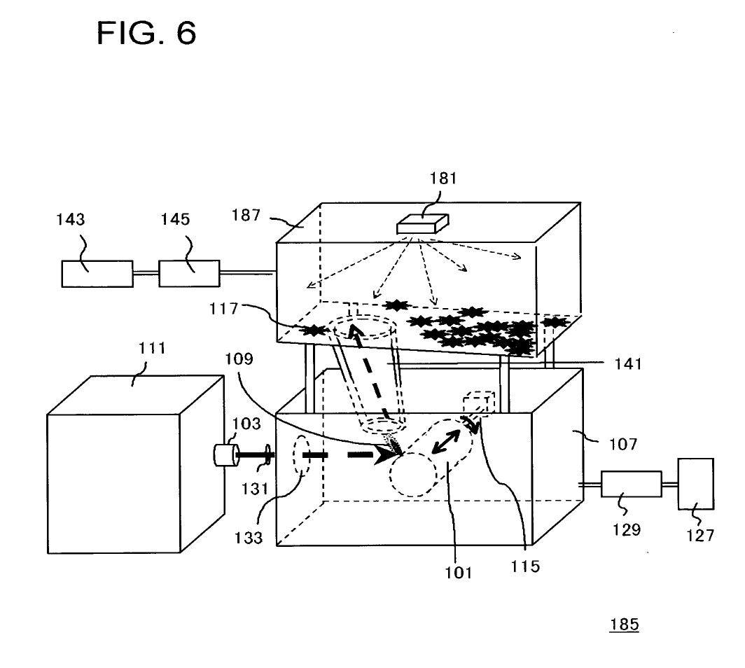

In the present embodiment, a structure of the bottom of the recovery chamber is different from that of the nanocarbon manufacturing apparatus described in the first or second embodiment. Hereinafter, the case of the nanocarbon manufacturing apparatus 184 described in the firs embodiment will be described as an example. FIG. 6 is a diagram showing a nanocarbon manufacturing apparatus 185 relating to the present embodiment.

In the nanocarbon manufacturing apparatus 185, the bottom face of a nanocarbon recovery chamber 187 is inclined. Thereby, the carbon nanohorn assemblies 117 moistened by a liquid sprayed from the sprayer 181 move in a lower direction at the bottom of the nanocarbon recovery chamber 187. Therefore, the carbon nanohorn assemblies 117 can be gathered at the lower region at the bottom of the nanocarbon recovery chamber 187. Therefore, the carbon nanohorn assemblies 117 can be more easily recovered.

### Fourth Embodiment

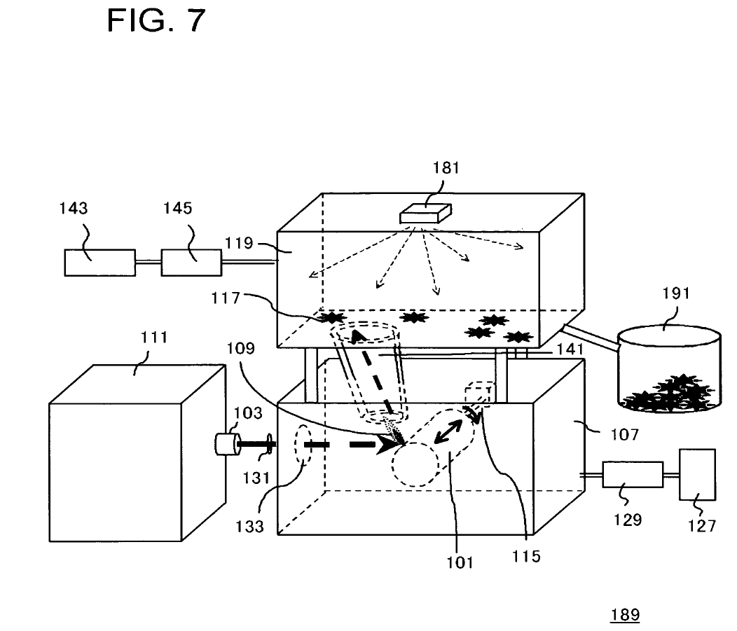

The present embodiment relates to a nanocarbon manufacturing apparatus further including a cartridge for recovery which is attachable and detachable with respect to the nanocarbon manufacturing apparatus 183 described in the first or the second embodiment. Hereinafter, the case of the nanocarbon manufacturing apparatus 184 described in the first embodiment will be described as an example. FIG. 7 is a diagram showing a nanocarbon manufacturing apparatus 189 relating to the present embodiment.

In the nanocarbon manufacturing apparatus 189, a cartridge for recovery 191 which is communicated with the bottom of the nanocarbon recovery chamber 119, and attachable and detachable is provided. Because the bottom of the cartridge for recovery 191 is positioned at a position lower than the bottom of the nanocarbon manufacturing apparatus 189, the carbon nanohorn assemblies 117 deposited on the bottom of the nanocarbon recovery chamber 119 are guided to the cartridge for recovery 191. Provided that the cartridge for recovery 191 is detached and the contents thereof are dried, the dried carbon nanohorn assemblies 117 can be more conveniently recovered.

### Fifth Embodiment

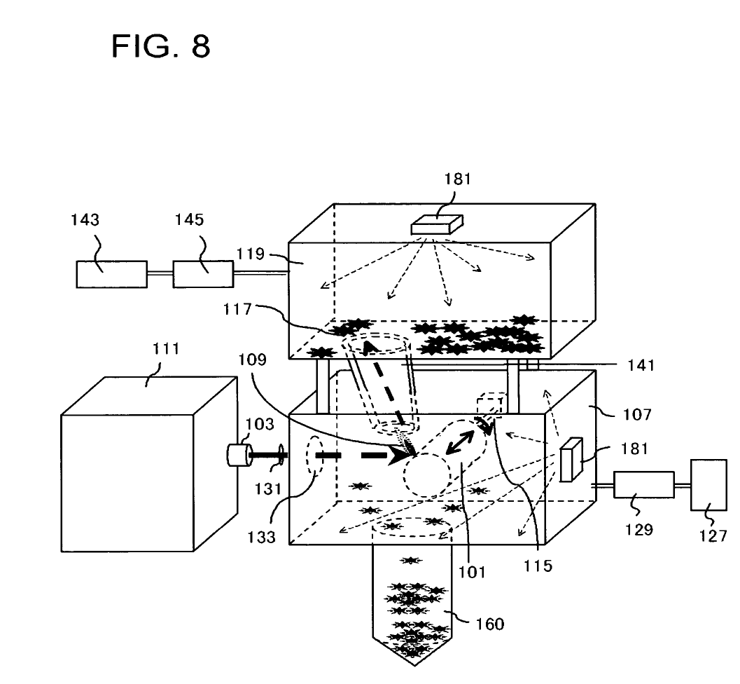

A carbon nanohorn manufacturing apparatus relating to the present embodiment is shown in FIG. 8. In this apparatus, a lower recovery chamber 160 is provided at a lower portion of the manufacturing chamber 107. Further, the sprayer 181 for spraying liquid into the manufacturing chamber 107 is further provided. The sprayer 181 may be structured, for example, so as to be the structure described in the first or second embodiment.

Due to the lower recovery chamber 160 being provided, the carbon nanohorn assemblies 117 are recovered into the nanocarbon recovery chamber 119 at the upper portion, and on the other hand, carbon vapor which has not recovered into the upper portion of the apparatus comes down by gravity from the carrier pipe 141, and is recovered into the lower recovery chamber 160. In accordance with this structure, carbon nanohorns whose horn lengths are short and carbon nanohorns whose horn lengths are long are respectively separated to be recovered into the nanocarbon recovery chamber 119 and the lower recovery chamber 160. In accordance with the present embodiment, a plurality of types of carbon nanohorns can be recovered separately.

Further, by splaying a liquid into the manufacturing chamber 107 as well, the carbon nanohorn assemblies 117 which have not been recovered by the nanocarbon recovery chamber 119 and have remained in the manufacturing chamber 107 are certainly moistened, and can be guided to the bottom of the manufacturing chamber 107. Therefore, the carbon nanohorn assemblies 117 can be efficiently recovered into the lower recovery chamber 160.

Note that, in the present embodiment, the sprayer 181 is provided at the manufacturing chamber 107. However, the sprayer 181 may be provided at the lower recovery chamber 160. In accordance therewith, the carbon nanohorn assemblies 117 can be more certainly deposited on the bottom of the lower recovery chamber 160, and the carbon nanohorn assemblies 117 can be restrained from splashing.

### Sixth Embodiment

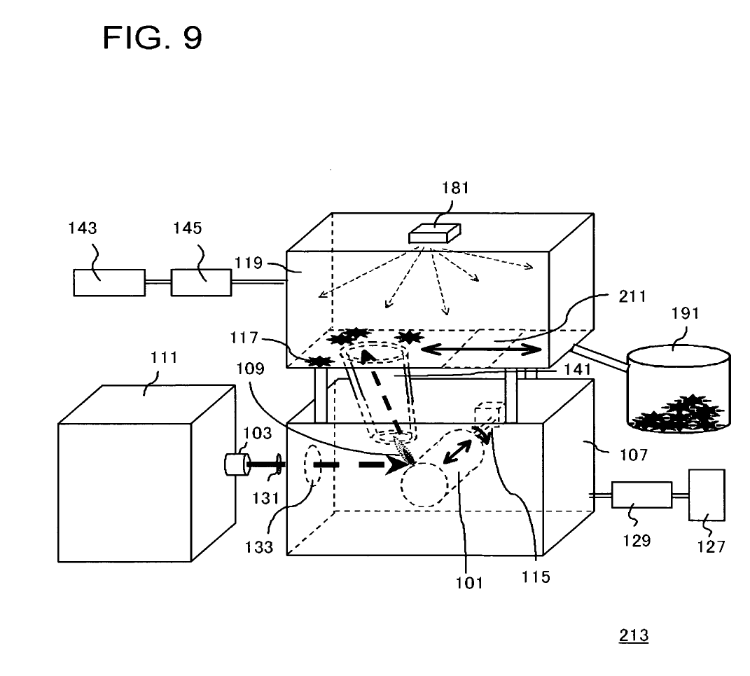

In the nanocarbon manufacturing apparatuses described in the above embodiments, a scraping unit 211 for scraping up and recovering the carbon nanohorn assemblies 117 deposited on the bottom of the nanocarbon recovery chamber 119 may be provided. Hereinafter, a case in which the present embodiment is applied to the nanocarbon manufacturing apparatus 189 described in the fourth embodiment will be described as an example. FIG. 9 is a diagram showing a structure of a nanocarbon manufacturing apparatus 213 relating to the present embodiment.

The nanocarbon manufacturing apparatus 213 has the tabular scraping unit 211 at the bottom of the nanocarbon recovery chamber 119. There is no limit to the structure of the scraping unit 211 except for the point that the carbon nanohorn assemblies 117 should be guided into the cartridge for recovery 191 by sliding the bottom face of the nanocarbon recovery chamber 119 like a paddle. Due to the scraping unit 211 being provided, the carbon nanohorn assemblies 117 deposited on the bottom of the nanocarbon recovery chamber 119 can be more certainly recovered. Note that the scraping unit 211 may be provided at the bottom of the manufacturing chamber 107. Further, the scraping unit 211 sliding up and down in these chamber may be further provided as needed. In accordance therewith, the moistened carbon nanohorn assemblies 117 can be more certainly gathered at the bottom of the chamber.

The present invention has been described above based on the embodiments. Those embodiments have been exemplified, and it will be understood by those skilled in the art that various modifications are possible and such modifications are within a scope of the present invention

For example, in the above embodiments, a scraping unit for scraping up the deposited carbon nanohorn assemblies 117 may be further provided at the bottom of the manufacturing chamber 107.

Further, in the above embodiments, the examples in which the graphite rod is used have been described. However, the shape of the graphite target is not limited to a tubular type, and may be formed in a sheet form, a bar shape, or the like.

Further, the shape, the size of the diameter, the length, and the shape of the tip of carbon nanohorns structuring the carbon nanohorn assemblies 117, and the spaces among carbon molecules and carbon nanohorns, or the like can be controlled variously in accordance with the conditions for irradiating the laser beam 103, and the like.

1. A nanocarbon manufacturing apparatus comprising:
a generation chamber which generates nanocarbon; and
a recovery chamber which recovers generated nanocarbon;
wherein a moistening unit which moistens generated nanocarbon is provided in said generation chamber or said recovery chamber.

2. A nanocarbon manufacturing apparatus comprising:
a light source which irradiates light onto a surface of a graphite target;
a recovery unit which recovers nanocarbon generated in irradiation of said light; and
a moistening unit which moistens said nanocarbon.

3. The nanocarbon manufacturing apparatus as set forth in claim 2, wherein said recovery unit has a recovery chamber, and a recovery pipe which guides said nanocarbon into said recovery chamber, and
said moistening unit moistens said nanocarbon in said recovery chamber.

4. The nanocarbon manufacturing apparatus as set forth in claim 2 or claim 3, further comprising a generation chamber in which said graphite target is installed,
wherein said moistening unit moistens said nanocarbon in said generation chamber.

5. The nanocarbon manufacturing apparatus as set forth in any of claims 1, 2 or 3,
wherein said moistening unit is a spray unit.

6. A method of manufacturing nanocarbon comprising:
irradiating light onto a surface of a graphite target; and moistening nanocarbon generated at said irradiating light.

7. The method of manufacturing nanocarbon as set forth in claim 6,
wherein said moistening nanocarbon includes spraying liquid on said nanocarbon.

8. The method of manufacturing nanocarbon as set forth in claim 6 or claim 7,
wherein said moistening nanocarbon sprays alcohol or an aqueous solution thereof on said nanocarbon.

9. A method of recovering nanocarbon comprising, after nanocarbon is generated, moistening and recovering said nanocarbon.
